(19) United States
(12) Patent Application Publication
(10) Pub. No.: US 2013/0138548 A1
(43) Pub. Date: May 30, 2013

(54) METHOD, APPARATUS, AND COMPUTER PROGRAM PRODUCT FOR IMPLEMENTING AN EXCHANGE FOR FUNGIBLE ASSETS

(71) Applicant: Motaavi, LLC, Durham, NC (US)

(72) Inventors: Kaiting Chen, Durham, NC (US); Alex Mao Zhang, Sunnyside, NY (US); Nikhil Bhargava, Durham, NC (US)

(73) Assignee: MOTAAVI, LLC, Durham, NC (US)

(21) Appl. No.: 13/687,279

(22) Filed: Nov. 28, 2012

Related U.S. Application Data
(60) Provisional application No. 61/563,841, filed on Nov. 28, 2011.

(51) Int. Cl. G06Q 40/04

(52) U.S. Cl. CPC G06Q 40/04
USPC 705/37

(57) ABSTRACT

A method, apparatus and computer program product are provided for implementing an exchange for fungible assets. A method aspect includes receiving a plurality of sell orders for the fungible asset, each sell order having a quantity for sale and a per unit selling price, and receiving a plurality of buy orders for the fungible asset, each buy order having a quantity wanted for purchase and a per unit buying price. The buy and sell orders are posted on an exchange. Buy and sell orders are then matched upon expiration of a time period, wherein the time period is determined as a function of at least buy and sell order parameters, and a clearing price is determined from the matched buy and sell orders so as to maximize the quantity of the fungible asset traded upon execution of trades of the matched buy and sell orders.

### REFERENCE TO RELATED APPLICATIONS

The present application claims the benefit of U.S. Provisional Patent Application Ser. No. 61/563,841, filed Nov. 28, 2011, the contents of which are incorporated herein in their entirety by reference.

### BACKGROUND OF THE DISCLOSURE

1. Field of the Disclosure

Aspects of the present application relate to fungible asset exchanges and, more particularly, to a method, apparatus, computer program product for implementing an exchange for fungible assets, such as normally illiquid assets, infrequently traded assets, or debt instruments.

2. Description of Related Art

In general, there exists a need for a market system which introduces or otherwise provides liquidity, for example, to normally illiquid assets, infrequently traded assets, or debt instruments. In some instances, it may also be desirable to provide for and allow price discovery/monitoring by participants in the market. More particularly, there exists a need for a market structure that allows fungible assets to be priced and traded closer to their “true economic value,” fair market price, true market value, or a price that the market will bear.

### BRIEF SUMMARY OF THE DISCLOSURE

The above and other needs are met by aspects of the present disclosure, wherein one such aspect relates to a method of implementing an exchange for fungible assets. Such a method comprises receiving a plurality of sell orders for the fungible asset, with each sell order having a quantity of the fungible asset for sale and a per unit selling price associated therewith. A plurality of buy orders for the fungible asset is also received, with each buy order having a quantity of the fungible asset wanted for purchase and a per unit buying price associated therewith. The buy orders and the sell orders are then posted on an exchange. Buy orders and sell orders are matched upon expiration of a first time period, wherein the first time period is determined as a function of at least buy and sell order parameters, and wherein a clearing price is determined from the matched buy and sell orders so as to maximize the quantity of the fungible asset traded upon execution of trades of the matched buy and sell orders.

In some aspects, the time period is determined as a function of at least buy and sell order parameters, wherein the buy and sell order parameter may include at least one of the received sell order quantity, the received buy order quantity, a reception rate of the received sell order quantity, a reception rate of the received buy order quantity, a range of the per unit selling price for the received sell order quantity, a range of the per unit buying price for the received buy order quantity, an order receipt time, and combinations thereof.

Generally, the matched and executed buy orders and sell orders are decremented from the posted buy orders and sell orders, following expiration of the first time period. A second time period may be originated after expiration of the first time period. In some instances, the buy orders and sell orders, not traded in the first time period, including any partially unfilled buy/sell orders, may be included with buy orders and sell orders received and posted during the second time period. In some aspects, the buy orders and the sell orders may be posted such that the buy orders and the sell orders are observable by exchange participants while, in other aspects, the buy orders and the sell orders may be posted such that at least the per unit price and the quantity of each of the buy orders and each of the sell orders are observable by exchange participants.

In addition, some method aspects may comprise determining a clearing price as a fair market price associated with the maximized quantity of the fungible asset traded upon execution of trades of the matched buy and sell orders, and executing the trades of the matched buy and sell orders at the fair market price. In some instances, the fair market price may be determined according to an intersection of price versus quantity data between a buying curve and a selling curve for the fungible asset. In particular aspects, the intersection of price versus quantity data may comprise a price range for a particular quantity, and determining a fair market price may comprise selecting a fair market price within the price range. Further, the determined fair market price may be evaluated according to one of a type of the fungible asset, a characteristic of the fungible asset, a historic market of the fungible asset, and combinations thereof.

In particular aspects, expiration of each time period may be within a time range, and the method comprises concealing the buy orders, the sell orders, and any expired time periods, each within the time range of a current time period, from observation by exchange participants so as to prevent manipulation thereof by the exchange participants. In other aspects, the method may comprise concealing the buy orders, the sell orders, and any expired time periods, each across a previous time period and within the time range of a current time period, from observation by exchange participants so as to prevent manipulation thereof by the exchange participants.

In another aspect of the present disclosure, an apparatus comprising processing circuitry is provided. The processing circuitry of this example embodiment may be configured to control the apparatus to at least perform the steps of the method aspect.

In yet another aspect of the present disclosure, a computer program product is provided comprising at least one non-transitory computer readable storage medium having computer program code stored thereon. The program code of this embodiment may include program code for at least performing the steps of the method aspect upon execution thereof.

Aspects of the present disclosure thus address the identified needs and provide other advantages as otherwise detailed herein. It will be appreciated that the above summary is provided merely for purposes of summarizing some example embodiments so as to provide a basic understanding of some aspects of the disclosure. As such, it will be appreciated that the above described example embodiments are merely examples and should not be construed to narrow the scope or spirit of the disclosure in any way. It will be appreciated that the scope of the disclosure encompasses many potential embodiments, some of which will be further described below, in addition to those here summarized.

### BRIEF DESCRIPTION OF THE SEVERAL VIEWS OF THE DRAWINGS

Having thus described the disclosure in general terms, reference will now be made to the accompanying drawings, which are not necessarily drawn to scale, and wherein:

FIG. 1 schematically illustrates a method of implementing an exchange for fungible assets, according to one aspect of the present disclosure;

FIGS. 2A and 2B schematically illustrate an exchange/market system for fungible assets, according to one aspect of the present disclosure;

FIG. 3 schematically illustrates a method of determining one of a “true economic value,” a fair market price, a true market value, or a price that the market will bear, for a fungible asset hosted on an exchange for such fungible assets, according to one aspect of the present disclosure;

FIGS. 4A-4G schematically illustrate various manners of selectively concealing particular buy and sell order data from exchange participants so as to prevent gaming or other manipulation of an exchange/market system for fungible assets, according to various aspects of the present disclosure;

FIG. 5 schematically illustrates an apparatus configured to implement an exchange for fungible assets, according to one aspect of the present disclosure; and

FIG. 6 schematically illustrates an exemplary cooperative scenario between a condition clearing exchange according to aspects of the present disclosure, and a continuous clearing exchange.

### DETAILED DESCRIPTION OF THE DISCLOSURE

The present disclosure now will be described more fully hereinafter with reference to the accompanying drawings, in which some, but not all aspects of the disclosure are shown. Indeed, the disclosure may be embodied in many different forms and should not be construed as limited to the aspects set forth herein; rather, these aspects are provided so that this disclosure will satisfy applicable legal requirements. Like numbers refer to like elements throughout.

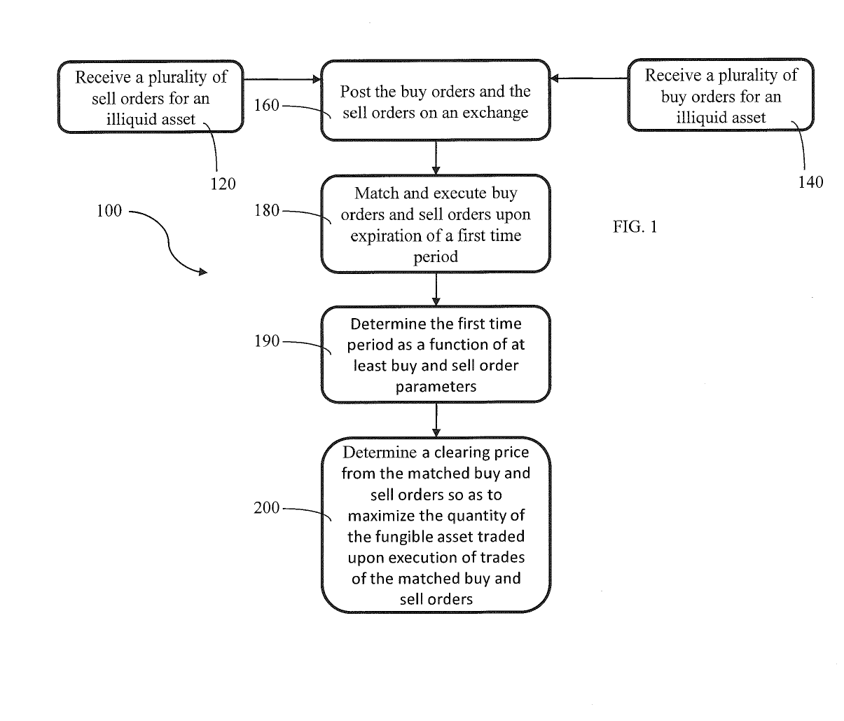

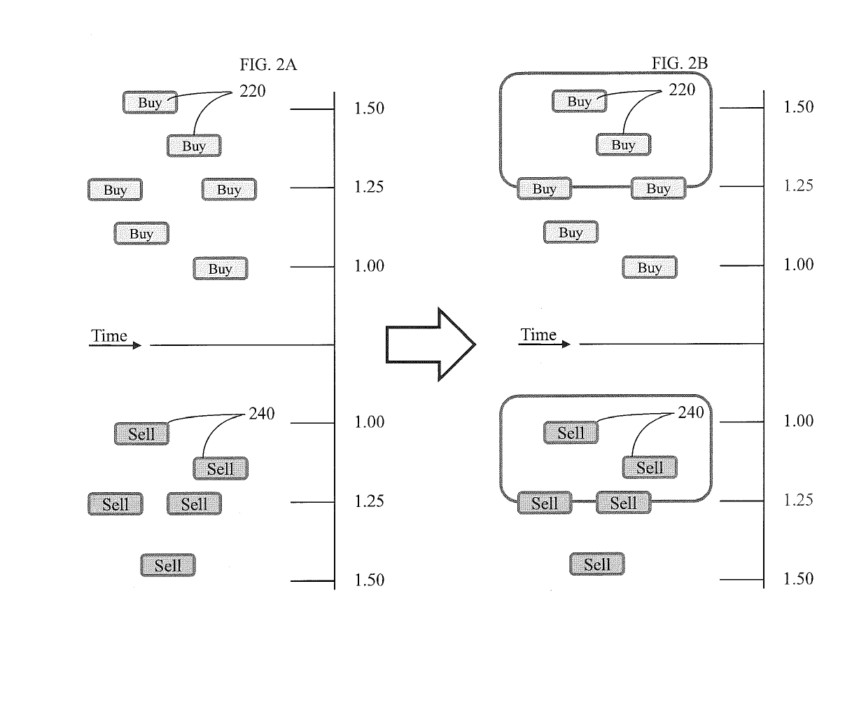

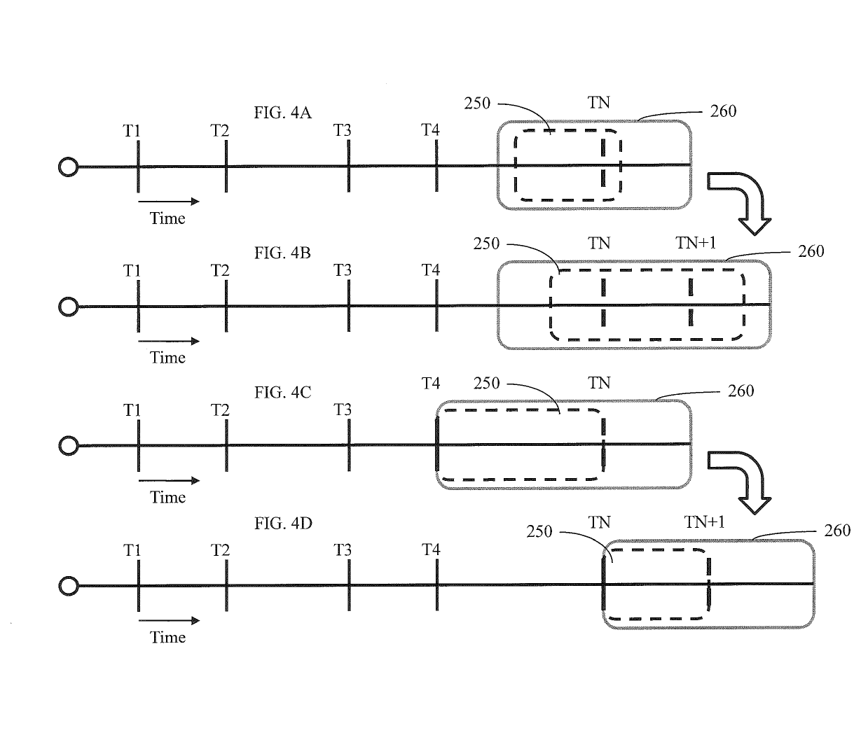

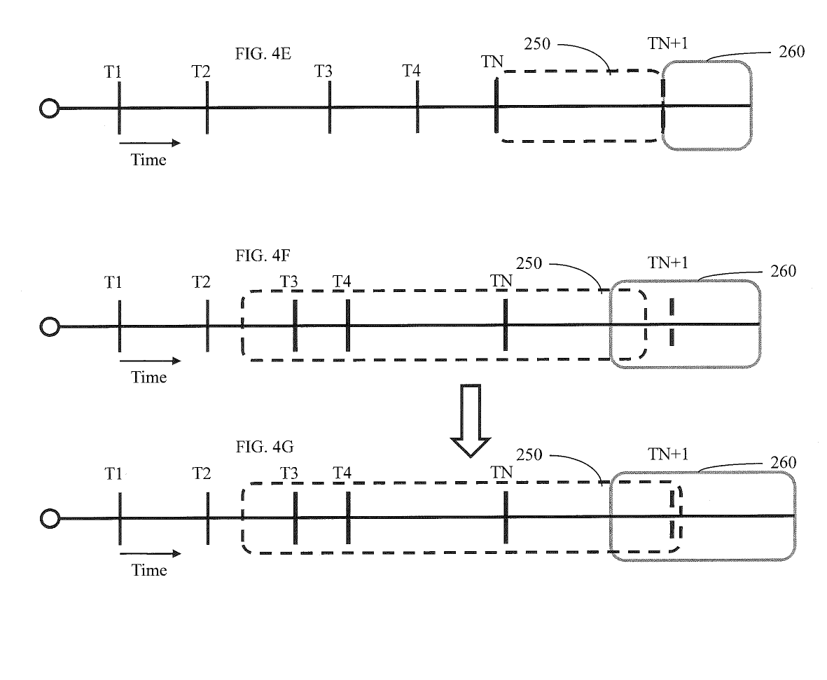

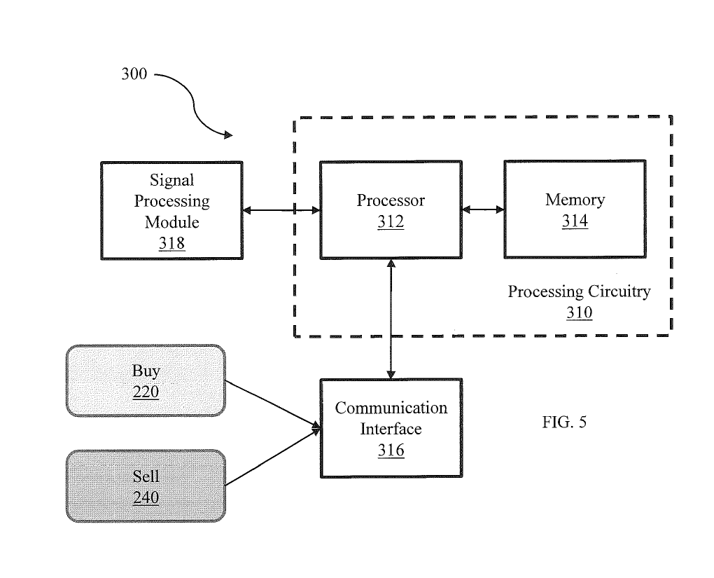

The present disclosure, in one aspect, is directed to a method of implementing an exchange, for example, for fungible assets such as illiquid assets, assets which may trade over-the-counter (OTC) subject to a discount (i.e., where purchasers may expect a liquidity premium), or debt instruments. As shown in FIG. 1, such a method aspect 100 may comprise receiving a plurality of sell orders for the fungible asset (Block 120 and FIG. 4, element 220), with each sell order having a quantity of the fungible asset for sale and a per unit selling price associated therewith. A plurality of buy orders for the fungible asset is also received (Block 140 and FIG. 4, element 240), with each buy order having a quantity of the fungible asset wanted for purchase and a per unit buying price associated therewith. The buy orders and the sell orders are then posted on an exchange (Block 160 and FIGS. 2A and 2B, elements 220 and 240, respectively). Buy orders and sell orders are matched upon expiration of a first time period (Block 180), wherein the first time period is determined as a function of at least buy and sell order parameters (Block 190), and wherein a clearing price is determined from the matched buy and sell orders so as to maximize the quantity of the fungible asset traded upon execution of trades of the matched buy and sell orders (Block 200 and generally FIGS. 2A and 2B). Accordingly, a market system may be realized which introduces or otherwise provides liquidity to certain fungible assets such as normally illiquid assets, infrequently traded assets, or debt instruments, while, in some aspects, providing for and allowing for price discovery/monitoring by participants in the market. More particularly, a market structure may be provided that allows certain fungible assets to be priced and traded closer to their “true economic value,” fair market price, true market value, or a price that the market will bear.

In some instances, aspects of the solution market structure disclosed herein may be considered a type of auction market which may include, for example, elements of call markets, Vickrey auctions, and/or Dutch auctions. That is, aspects of the solution market structure disclosed herein may comprise a “conditional clearing” market, in that clearing events (i.e., execution of matched buy and sell orders) happen upon fulfillment of a particular condition. In one aspect of such a market, buy orders and sell orders are posted and accumulate in a closed “order book” (though one skilled in the art will appreciate that the book may be fully closed or may include best bid/ask or even best top 3 buy/sell orders, which may provide an adjustable level of transparency. In some instances, best bid/ask may be included without the quantity demanded, so as to further attenuate subsequent participant orders.). Some buy and sell orders may cross prices (i.e., the buy order price and quantity may meet or exceed the sell order price and quantity), but those matching buy and sell orders are not immediately executed and cleared from the posted buy and sell orders on the market/exchange. Instead, as buy and sell orders for the particular asset are submitted and received for posting, particular statistics are calculated from overall market activity, and a trigger is automatically and dynamically calculated as to when the open order period will be closed. Once the trigger is set, a clearing price is calculated and the applicable matched buy orders and sell orders are executed/cleared at that clearing price (i.e., “true economic value,” fair market price, true market value, or a price that the market will bear). With this type of “conditional clearing” market system, the open time period during which buy and sell orders can be posted to the exchange can be imperceptible or it can last for minutes, hours, or days, depending, for example, on overall activity on the exchange/market associated with the particular asset or on exchange operator parameters.

Aspects of the disclosure thus provide an exchange/market system that may be considered incentive-compatible for both buyers and sellers. More particularly, aspects of the disclosure may benefit both buyers and sellers by pricing/executing matched buy and sell orders closer to a true economic value (or fair market price, true market value, or a price that the market will bear), as compared to other types of exchange/market systems. One result is that aspects of the present disclosure may provide an exchange/market configured to clear a higher volume of particular assets at truer prices than, for example, conventional exchange/market structures that may implement more traditional auction models or even market makers. One aspect of the present disclosure further provides an exchange/market system that eliminates or minimizes the risk of the exchange being manipulated or “gamed.” That is, particular aspects may prevent buyers, sellers, or other market participants from manipulating the exchange/market to change the clearing price for a particular time period, as will be addressed further herein. Aspects of the present disclosure may further provide an exchange/market that can be implemented to operate in conjunction with a “continuous clearing” market to allow exchange/market participants to either access immediate liquidity of a particular asset, possibly at a discounted price (i.e., a “continuous clearing” exchange/market), or obtain the “best” price (i.e., “true economic value,” fair market price, true market value, or a price that the market will bear) for the particular asset over a given time period or interval (i.e., a “conditional clearing exchange/market according to aspects of the present disclosure), wherein that time period or interval may be longer than the time required to execute matched buy and sell orders under a “continuous clearing” system. Aspects of the present disclosure may also provide an exchange/market that is scalable. One skilled in the art will also appreciate that such an exchange/market may also be suitable for handling a wide variety of illiquid, but fungible, assets, including, for example, securities, limited partnership (LP) interests (i.e., some hedge funds and venture capital funds are structured as Limited Partnerships. The fund manager is the General Partner, and the individual investors are each considered Limited Partners. The limited partnership interest is analogous to a share in a corporation. Limited Partnership interest holders are thus holding an illiquid asset. Often, the only way to sell this asset is to negotiate for its value one on one or to list it on a conditionally clearing market), complex debt instruments and derivatives, commodities and futures, real property, and rights and contracts (i.e., assignments for the benefit of creditors, water rights, etc.), though this list is not intended to be limiting in any manner. As such, reference herein to “fungible assets” will be understood to cover many different types of assets as otherwise noted herein.

In some method aspects, the time period may be determined as a function of at least particular buy and sell order parameters. Such buy and sell order parameter may include, for example, at least one of the received sell order quantity, the received buy order quantity, a reception rate of the received sell order quantity, a reception rate of the received buy order quantity, a range of the per unit selling price for the received sell order quantity, a range of the per unit buying price for the received buy order quantity, an order receipt time, and combinations thereof. That is, in general, the time period may reflect, for example, the relative activity associated with and/or interest in the particular asset on the exchange, as well as whether the exchange/market participants are in relative agreement as to the value of the asset. As disclosed herein and illustrated in FIGS. 2A and 2B, the buy and sell orders may be posted at different times and have differing parameters such as, for instance, price and quantity. Even though particular buy and sell orders may match and correspond in parameters, such trades or exchanges are not immediately executed. That is, buy orders and sell orders are not matched until expiration of a first time period, wherein the first time period is determined as a function of at least buy and sell order parameters, and wherein a clearing price is determined from the matched buy and sell orders so as to maximize the quantity of the fungible asset traded upon execution of trades of the matched buy and sell orders.

In other aspects, the time period may also consider characteristics of any preceding time periods (where such time periods exist). In other aspects, the initial time period may be determined using any or all of the possible contributing factors disclosed herein. That is, one skilled in the art will appreciate that, where the exchange/market for the asset is unprecedented in context, various factors may be necessary or otherwise desirable for consideration in determining the conditions of the original trades on that market. In some instances, there may also be a parameter for the initial time period that may be manually selected by the exchange operator. For example, that parameter might be a trigger that either originates a calculation of the remaining time in the time period, or a trigger that stops the time period and then originates the calculation of the clearing price. Accordingly, one skilled in the art will appreciate that the initial time period may not necessarily provide the most accurate time period or clearing price for a market without precedent in hosting trading of the particular asset. It further follows that subsequent time periods may provide more accurate or representative results for determining the duration of the time period, as well as the clearing price, having the benefit of the results of previous time periods. Where no such historical information may exist, estimations based on characteristics of the asset and the present market activity may be used. For example, a decreasing order submission rate can be used, but the point at which the rate is sufficiently low to end the period may be set by the exchange operator prior to the initial opening of the market for that asset. Accordingly, the respective time period may be set according to, for example, rate, spread, historical order activity, volume, bias (more sells, or more buys), or any other suitable parameters.

In addition, some method aspects may comprise determining a clearing price as a fair market price associated with the maximized quantity of the fungible asset traded upon execution of trades of the matched buy and sell orders, and then executing the trades of the matched buy and sell orders at the fair market price. That is, concurrently with determining the time period for matching the posted buy and sell orders, aspects of the present disclosure may also determine a fair market price (i.e., “clearing price”) at which the trades are executed. In some instances, the clearing price may be statistically-determined, for example, from at least the buy and sell order parameters, and updated, as necessary, as more buy and/or sell orders are posted to the exchange. Upon determining the time period “trigger” for matching the buy and sell orders posted on the exchange, the fair market price is also determined from the matched buy and sell orders so as to maximize the quantity of the fungible asset traded upon execution of trades of the matched buy and sell orders, and that clearing price becomes fixed or otherwise set. As such, the trades of the matched buy and sell orders are executed at that fair market price. In the example shown in FIG. 2B, the fair market price is determined, for example, as 1.25 per unit. Among some assumptions/presumptions of the exchange are that, for example, participants posting buy orders on the exchange at a higher price per unit would accept purchases at a lower per unit price (i.e., fair market price) upon execution, and that participants posting sell orders on the exchange at a lower price per unit would accept sales at a higher per unit price (i.e., fair market price) upon execution (i.e., monotonic supply and demand curves). Otherwise, one skilled in the art will appreciate that FIGS. 2A and 2B are provided for illustrative purposes only and do not necessarily provide all relevant parameters of the buy and sell orders posted to the exchange such as, for example, quantities, whether to be bought or sold, any particular relation to the time involved, or any particular relation to the determined fair market price. In this regard, FIGS. 2A and 2B do illustrate one inventive concept of the present disclosure of determining a fair market price from the matched buy and sell orders associated with a maximized quantity of the fungible asset traded upon execution of trades of the matched buy and sell orders, and then executing the trades of the matched buy and sell orders at the fair market price.

FIGS. 2A and 2B further schematically illustrate a hypothetical presentation of a number of orders to demonstrate that every order is considered when determining the clearing price. However, whether the individual orders are visible to market participants or not may be, for example, a decision for the exchange operator based on the nature of the asset. For example, the more illiquid the asset, the more it may be desirable to conceal the posted orders from the market participants. In this regard, one skilled in the art will appreciate that equity, even relatively liquid equity, can be sold with all orders concealed from market participants. In such instances, it may be expected that each participant, in the absence of such market information, may be more truthful or realistic as to the valuation of the asset being traded. However, one limitation of trading equity with a closed order book may be low order rates and low turnover/clearing of the asset.

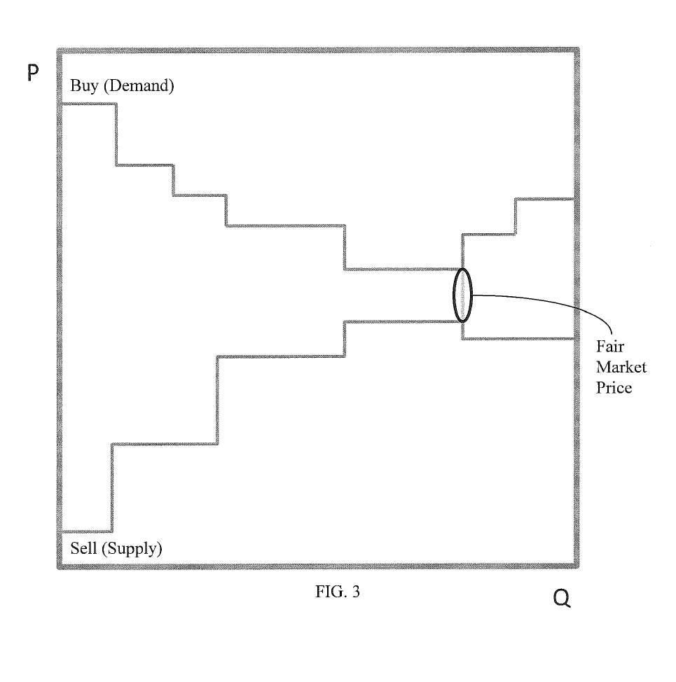

In some instances, the fair market price may be determined according to an intersection of price versus quantity data between a buying curve and a selling curve for the fungible asset as shown, for example, in FIG. 3, that may result in the maximized transacted quantity of the asset. In particular aspects, as also shown in FIG. 3, the intersection of price versus quantity data may comprise a price range as the “fair market price” for a particular quantity of the asset (i.e., shares). In such instances, determining a fair market price may comprise selecting a fair market price within the price range. In one example, the fair market price may be designated as the median of the price range. In another example, the price range may be a result of buy limit orders overlapping with sell limit orders. Along this price range, there may exist a variable number of units that could be transacted. As such, the fair market price may be selected from the price range as the price that results in the transaction of the most units. As a result, some buy/sell orders will be completely filled, while others may only be partially filled, though one underlying preference is to execute transactions that clear the highest volume of units of the asset. Accordingly, the median of the price range may be arbitrarily chosen if there is impartiality as to whether buyers or sellers may end up receiving an economic surplus or bonus that may be encompassed in the price range.

One skilled in the art will further appreciate, however, that the fair market price determined herein may also be evaluated according to characteristics not necessarily associated with the buy and sell orders posted on the exchange. For example, the determined fair market price may also be evaluated according to one of a type of the fungible asset, a characteristic of the fungible asset, a historic market of the fungible asset, and combinations thereof. One skilled in the art will also appreciate, however, that such further evaluation may be used to supplement, adjust, or otherwise have an effect on the fair market price determined in other manners (i.e., dynamically as a statistical quantity based upon exchange activity). Such evaluation may be useful, for example, if the asset required a reference price before initial commencement of trading on the exchange.

In addition, one skilled in the art will appreciate that reference to a “fair market price” herein is also not intended to be limiting with respect to the determination of the clearing price. For example, reference to a “fair market price” may signify, for example, that the quantity is a “true economic value,” a true market value, or a essentially a price that the market will bear. Though not particularly shown in FIGS. 2A and 2B, the matched and executed buy orders and sell orders are decremented from the posted buy orders and sell orders (i.e., decremented from the buy and sell orders posted on the exchange), following expiration of the first time period.

A second time period (ending at time T2) may be originated after expiration of the first time period (ending at time T1) as shown, for example, in FIGS. 4A-4G, wherein subsequent time periods (ending at times T3, T4, TN, etc.) may be successively implemented, as will be appreciated by one skilled in the art. In some instances, as previously noted, the buy orders and sell orders, not traded in the first time period, may be included with buy orders and sell orders received and posted during the second time period. In some instances, any partially filled orders that remain from the first time period may also be included. In particular aspects, the exchange may be considered as a timeline of buy and sell orders, wherein such buy and sell orders may be placed or otherwise located at various times along a time (horizontal) axis. With respect to FIGS. 4A-4G, each vertical line or hash may represent the expiration of a particular time period where the matched buy and sell orders are executed at the fair market price for that time period. In some aspects, the buy orders and the sell orders may be posted so as to be observable by exchange participants. In other aspects, the buy orders and the sell orders may be posted such that at least (or only) the per unit price and the quantity of each of the buy orders and each of the sell orders are observable by exchange participants. In yet other aspects, the buy orders and the sell orders may be posted so as to not be observable by exchange participants.

In some aspects, expiration of each time period may be within or otherwise associated with a time range 250 (for expiration of time period TN), as shown, for example, in FIGS. 4A-4G. Such a window or period of time 250 in which the expiration (TN) of the current time period can occur may originate at some time after the previous time period expiration (in the illustrated examples, following expiration T4 of the previous time period) as shown, for example, in FIGS. 4A and 4B, and may extend up to the current time. In some instances, as shown, for example, in FIG. 4B, the time range 250 may possibly encompass the expiration of several subsequent time periods (i.e., TN and TN+1). As previously disclosed, the expiration of the respective time period is determined by a number of factors associated, for example, with the buy and sell order parameters of the buy and sell orders posted within the time period 250. Of course, one skilled in the art will appreciate that the time period 250 may originate at the expiration of the previous time period as shown, for example, in FIGS. 4C and 4D, and shift along the timeline as subsequent time periods expire, as shown, for example, in the progression between FIGS. 4A and 4B, or between FIGS. 4C and 4D.

In some instances, aspects of the method may comprise concealing the posted buy orders, the posted sell orders, and any expired time periods, each within the time range 250 of a current time period, and/or concealing the buy orders, the sell orders, and any expired time periods, each across a previous time period and within the time range 250 of a current time period, from observation by exchange participants so as to prevent manipulation thereof by the exchange participants. That is, as previously disclosed, the buy orders and the sell orders may be posted to be observable by exchange participants, to not be observable by exchange participants, or such that at least (or only) the per unit price and the quantity of each of the buy orders and each of the sell orders are observable by exchange participants. If the exchange participants are also allowed to observe the time between time period expirations (i.e., the timing between clearing events in which matched buy and sell orders are executed, otherwise referred to herein as the “periodicity” or clearing events), it may be possible for particular exchange participants to “game” or otherwise manipulate the exchange to there favor, for example, in terms of the “fair market price.” As such, aspects of the present disclosure provide that certain posted buy and sell orders, and possibly some clearing events, may be excluded or otherwise prevented from being observed by the exchange participants, so as to prevent gaming or other manipulation of the exchange by exchange participants. For example, such an “occlusion period” 260 may include at least the time range 250 of the current time period, as well as a portion of the time between the expiration of the previous time period and the origination of the time range 250 (see, e.g., FIGS. 4A and 4B) or the entire time between the expiration of the previous time period and origination of the time range 250 (see, e.g., FIGS. 4C and 4D). That is, in some aspects, the occlusion period 260 may conceal the current time period and the immediately previous time period, while the time range 250 may just include the immediately previous time period (see, e.g., FIGS. 4C and 4D). Therefore, in such instances, all currently posted open buy and sell orders are concealed from the exchange participants, as well as all buy and sell orders within the current time period used to determine the expiration of the current period. Generally, the occlusion period 260 should conceal the posted buy and sell orders of at least the current period in order for the exchange/market to be able to prevent gaming or manipulation.

However, in some aspects, for example, if the timing of the clearing events is sufficiently random, the time range 250 of the current time period may not necessarily be required to be concealed from the exchange participants (see, e.g., FIG. 4E), and can thus be placed outside the occlusion period 260, if implemented.

FIGS. 4F and 4G schematically illustrate further aspects of the present disclosure, wherein the further the time range 250 is extended back to previous time periods, the more the period length will exhibit a phase shift to current market conditions. In addition, the larger the extent of the time range 250, the more hysteresis will be exhibited in the period length. When both of these factors are combined the period length is dampened. In such instances, the time range 250 is not necessarily tied to a particular clearing event and, as such, may provide high dampening in period length and may serve to protect exchange participants from relatively chaotic behavior immediately preceding a clearing event, when the time of the clearing event can be estimated. More particularly, as shown in FIGS. 4F and 4G, the occlusion period 260 may serve to conceal historical order information from market participants. The duration of the occlusion period 260 can be adjusted by the exchange operator, but at a minimum, it must extend for the current time period so no presently open buy/sell orders can be seen (unless the operator chooses to reveal best bid/ask or some other order information) by the market participants. The time range 250 extends over the time periods that are used in calculating the length of the current time period, though the time range can be extended over as many previous time periods as desired, and can also include part of the current time period (i.e., the time range 250 may include market activity for the first 5 minutes of the current time period in calculating the duration or expiration of the current time period). The more historical previous time periods covered by the time range, the more shock resistant that the market may be. For example, if the previous five time periods (arbitrary) display “normal” activity on the market, and the current period displays abnormally high activity, and the time range 250 covers the previous five periods and perhaps part of the current period, the time range 250 thus configured may ensure the chaos of the current time period does not lead to the current time period being abnormally short due to rate, spreads, or some other variable. That is, the time period 250 thus configured may extend the current time period based on the characteristics of previous five periods, thus shielding exchange participants from buffeting or undesirable effects of instability in the market. The time range 250 may thus be adjusted, as necessary to change the amount of damping desired. In some instances, the occlusion period 260, which may influence the orders placed by market participants by limiting the available market information, may affect the information used in conjunction with the time range 250 to determine the current time period. For example, extending the occlusion window 260 to conceal more historical information might improve damping effects on price fluctuations on the market, particularly when combined with an extended time range 250. In other instances, a short duration occlusion window 260 combined with a short duration time range 250 might lead to greater price movement, but might also be desirable if there is high rate of order placement and turnover/clearing of the asset due to higher demand. However, excessive damping might lead to market dislocations where the economic conditions that affect the performance of the asset are moving faster than the market will allow the asset to be priced. In this regard, hysteresis may render the occlusion window a dynamic concept by allowing the occlusion window 260 to manage the present market condition by reacting to historical conditions.

In yet another aspect of the present disclosure, a computer program product is provided comprising at least one non-transitory computer readable storage medium having computer program code stored thereon. The program code of this embodiment may include program code for at least performing the steps of the method aspect upon execution thereof. That is, it will be understood that each block of the flowchart in FIG. 1, and/or combinations of blocks in the flowchart, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s), which may embody the procedures described herein, may be stored by one or more memory devices of a mobile terminal, server, or other suitable computing device and executed by a processor in the computing device. In some embodiments, the computer program instructions comprising the computer program product(s) which embody the procedures described above may be stored by memory devices of a plurality of computing devices. As will be appreciated, any such computer program product may be loaded onto a computer or other programmable apparatus to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart block(s). The computer program instructions of one or more computer program products may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s). Accordingly, blocks of the flowchart support combinations of means for performing the specified functions. It will also be understood that one or more blocks of the flowchart, and combinations of blocks in the flowchart, may be implemented by special purpose hardware-based computer systems which perform the specified functions, or combinations of special purpose hardware and computer program product(s).

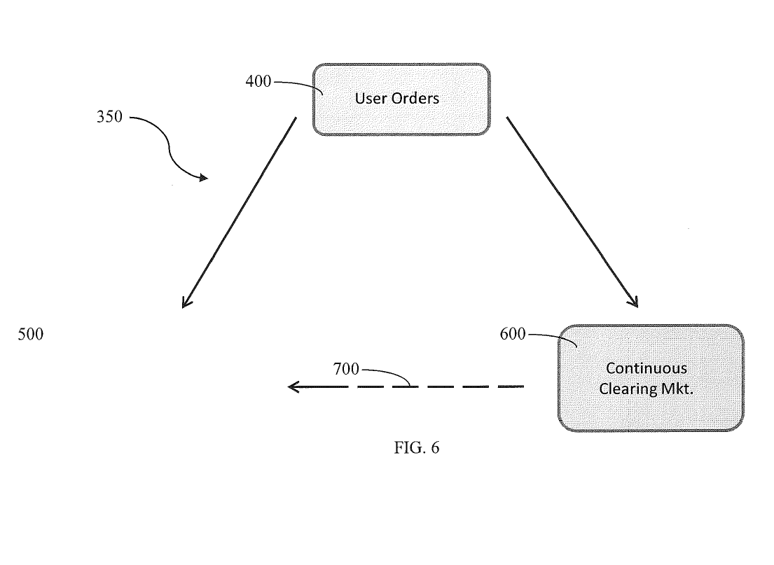

In yet another aspect of the present disclosure, an apparatus comprising processing circuitry is provided. The processing circuitry of this example embodiment may be configured to control the apparatus to at least perform the steps of the method aspect. In this regard, FIG. 5 illustrates a block diagram of an apparatus 300 that can be implemented on a server in accordance with some example embodiments. In this regard, when implemented on a computing device, such as a server, apparatus 300 can enable a computing device to operate within a system in accordance with one or more example embodiments. It will be appreciated that the components, devices or elements illustrated in and described with respect to FIG. 5 below may not be mandatory and thus some may be omitted in certain embodiments. Additionally, some embodiments can include further or different components, devices or elements beyond those illustrated in and described with respect to FIG. 5.

In some example embodiments, the apparatus 300 can include processing circuitry 310 that is configurable to perform actions in accordance with one or more example embodiments disclosed herein, such as method aspects previously disclosed. In this regard, the processing circuitry 310 can be configured to perform and/or control performance of one or more functionalities of the apparatus 300 in accordance with various example embodiments, and thus can provide means for performing functionalities of the apparatus 300 in accordance with various example embodiments. The processing circuitry 310 can be configured to perform data processing, application/software execution and/or other processing and management services according to one or more example embodiments.

In some embodiments, the apparatus 300 or a portion(s) or component(s) thereof, such as the processing circuitry 310, can include one or more chipsets, which can each include one or more chips. The processing circuitry 310 and/or one or more further components of the apparatus 300 can therefore, in some instances, be configured to implement an embodiment on a single chip or chipset. In some example embodiments in which one or more components of the apparatus 300 are embodied as a chipset, the chipset can be capable of enabling a computing device to operate in the system 200 when implemented on or otherwise operably coupled to the computing device. Thus, for example, one or more components of the apparatus 300 can provide a chipset configured to enable a computing device to operate over a network.

In some example embodiments, the processing circuitry 310 can include a processor 312 and, in some embodiments, such as that illustrated in FIG. 5, can further include a memory 314. The processing circuitry 310 can be in communication with or otherwise control a communication interface(s) 316 and/or selection control module 318, as further disclosed herein.

The processor 312 can be embodied in a variety of forms, as will be appreciated by one of ordinary skill in the art. For example, the processor 312 can be embodied as various processing means such as a microprocessor, a coprocessor, a controller or various other computing or processing devices including integrated circuits such as, for example, an application-specific integrated circuit (ASIC), a field-programmable gate array (FPGA), some combination thereof, or the like. Although illustrated as a single processor, it will be appreciated that the processor 312 can comprise a plurality of processors. The plurality of processors can be in operative communication with each other and can be collectively configured to perform one or more functionalities of the apparatus 300 as described herein. In some example embodiments, the processor 312 can be configured to execute instructions that can be stored in the memory 314 or that can be otherwise accessible to the processor 312. As such, whether configured by hardware or by a combination of hardware and software, the processor 312 is capable of performing operations according to various embodiments while configured accordingly.

In some example embodiments, the memory 314 can include one or more memory devices. The memory 314 can include fixed and/or removable memory devices. In some embodiments, the memory 314 can provide a non-transitory computer-readable storage medium that can store computer program instructions (i.e., software) that can be executed by the processor 312. In this regard, the memory 314 can be configured to store information, data, applications, instructions and/or the like for enabling the apparatus 300 to carry out various functions in accordance with one or more example embodiments, such as the method aspects disclosed herein. In some embodiments, the memory 314 can be in communication with one or more of the processor 312, communication interface(s) 316, or selection control module 318 via a bus(es) for passing information among components of the apparatus 300.

The apparatus 300 may further include a communication interface 316. The communication interface 316 may enable the apparatus 300 to receive a signal that may be sent by another computing device, such as over a network. In this regard, the communication interface 316 may include one or more interface mechanisms for enabling communication with other devices and/or networks (i.e., for receiving buy orders 220 and sell orders 240). As such, the communication interface 316 may include, for example, an antenna (or multiple antennas) and supporting hardware and/or software for enabling communications with a wireless communication network (e.g., a cellular network, WLAN, and/or the like) and/or a communication modem or other hardware/software for supporting communication via cable, digital subscriber line (DSL), USB, FireWire, Ethernet or other wireline networking methods.

The apparatus 300 can further include selection control module 318. The selection control module 318 can be embodied as various means, such as circuitry, hardware, a computer program product comprising a computer readable medium (for example, the memory 314) storing computer readable program instructions and executable by a processing device (for example, the processor 312), or some combination thereof for performing particular operations or functions of aspects of the present disclosure, as otherwise disclosed herein. In some embodiments, the processor 312 (or the processing circuitry 310) can include, or otherwise control the selection control module 318.

Many modifications and other embodiments of the inventions set forth herein will come to mind to one skilled in the art to which these inventions pertain having the benefit of the teachings presented in the foregoing descriptions and the associated drawings. For example, as shown in FIG. 6, aspects of the present disclosure may be combined with other types of exchanges/markets to provide a tandem market structure 350. More particularly, as disclosed herein, aspects of the present disclosure may provide a conditional clearing exchange/market structure 500 that seeks to determine a fair market price associated with the maximized quantity of the asset traded upon execution of matched buy and sell orders, and then executes the matched buy and sell orders at the fair market price. A user wanting to obtain prices for an asset that are most representative of the true economic value or fair market price of that asset being bought or sold will send respective orders 400 to the conditional clearing exchange/market 500, with the understanding that the conditional clearing exchange/market 500 may not set a price and clear orders immediately (i.e., not necessarily immediate liquidity), but when such clearing occurs, a better price may be realized than would otherwise be available for fungible assets using conventional market structures.

Alternately, users that want to have orders immediately cleared, at prevailing price on an ongoing market system, regardless of whether the prevailing price is representative of the true market value or fair market price, may post orders 400 on a continuous clearing market (i.e., NYSE or NASDAQ) 600. The prevailing price on such a continuous clearing market may not be necessarily be representative of the true economic value of the particular asset being bought or sold because, for instance, such a market system may reflect a price for the asset based on other factors. More immediate liquidity is realized, as orders posted on the market are immediately cleared (i.e., a trade is executed) once buy and sell orders are matched at the same price (for the desired quantity), or otherwise overlap such that a trade can be conducted.

As such, according to other aspects of the present disclosure, user orders 400 can be directed to both the conditional clearing exchange 500 and the continuous clearing exchange 600, or from the continuous clearing market order book to the conditional clearing market order book (see, e.g., element 700), for example, in order to enhance the resolution at which the conditional clearing market can determine a clearing price (i.e., a fair market price), which may lead to a better price and/or greater liquidity of the asset on the conditional clearing market. One skilled in the art will also appreciate that a continuous clearing market may be adjusted to reflect certain levels of order transparency (i.e., ranging from best bid/ask to a full open order book), which may possibly influence user behavior and/or adjust or equilibrate asset pricing between the conditional clearing exchange 500 and the continuous clearing exchange 600 of the tandem market structure 350. For example, truthfulness in pricing (i.e., buy/sell orders closer to the fair market price) on the continuous clearing market may be incentivized if the continuous clearing market is structured for only best bid/ask.

Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

That which is claimed:

1. A method of implementing an exchange for fungible assets, said method comprising:
receiving a plurality of sell orders for the fungible asset, each sell order having a quantity of the fungible asset for sale and a per unit selling price associated therewith;
receiving a plurality of buy orders for the fungible asset, each buy order having a quantity of the fungible asset wanted for purchase and a per unit buying price associated therewith;
posting the buy orders and the sell orders on an exchange;
matching buy orders and sell orders upon expiration of a first time period;
determining the first time period as a function of at least buy and sell order parameters; and
determining a clearing price from the matched buy and sell orders so as to maximize the quantity of the fungible asset traded upon execution of trades of the matched buy and sell orders.

2. A method according to claim 1, wherein determining the time period further comprises determining the time period as a function of at least buy and sell order parameters, the buy and sell order parameter including at least one of the received sell order quantity, the received buy order quantity, a reception rate of the received sell order quantity, a reception rate of the received buy order quantity, a range of the per unit selling price for the received sell order quantity, a range of the per unit buying price for the received buy order quantity, an order receipt time, and combinations thereof.

3. A method according to claim 1, comprising decrementing the matched and executed buy orders and sell orders, from the posted buy orders and sell orders, following expiration of the first time period.

4. A method according to claim 1, wherein posting the buy orders and the sell orders further comprises posting the buy orders and the sell orders on an exchange such that the buy orders and the sell orders are observable by exchange participants.

5. A method according to claim 1, comprising originating a second time period after expiration of the first time period.

6. A method according to claim 5, comprising including the buy orders and sell orders, not traded in the first time period, with buy orders and sell orders received and posted during the second time period.

7. A method according to claim 1, wherein posting the buy orders and sell orders further comprises posting the buy orders and the sell orders such that at least the per unit price and the quantity of each of the buy orders and each of the sell orders are observable by exchange participants.

8. A method according to claim 1, determining a clearing price further comprises determining a clearing price as a fair market price associated with the maximized quantity of the fungible asset traded upon execution of trades of the matched buy and sell orders, and executing the trades of the matched buy and sell orders at the fair market price.

9. A method according to claim 8, wherein determining a fair market price comprises determining the fair market price according to an intersection of price versus quantity data between a buying curve and a selling curve for the fungible asset.

10. A method according to claim 9, wherein the intersection of price versus quantity data comprises a price range for a particular quantity of the fungible asset, and determining a fair market price comprises selecting a fair market price within the price range.

11. A method according to claim 8, wherein determining a fair market price comprises evaluating the determined fair market price according to one of a type of the fungible asset, a characteristic of the fungible asset, a historic market of the fungible asset, and combinations thereof.

12. A method according to claim 5, wherein expiration of each time period is within a time range, and the method comprises concealing the buy orders, the sell orders, and any expired time periods, each within the time range of a current time period, from observation by exchange participants so as to prevent manipulation thereof by the exchange participants.

13. A method according to claim 5, wherein expiration of each time period is within a time range, and the method comprises concealing the buy orders, the sell orders, and any expired time periods, each across a previous time period and within the time range of a current time period, from observation by exchange participants so as to prevent manipulation thereof by the exchange participants.

14. An apparatus comprising processing circuitry configured to control the apparatus to at least:
receive a plurality of sell orders for the fungible asset, each sell order having a quantity of the fungible asset for sale and a per unit selling price associated therewith;
receive a plurality of buy orders for the fungible asset, each buy order having a quantity of the fungible asset wanted for purchase and a per unit buying price associated therewith;
post the buy orders and the sell orders on an exchange;
match buy orders and sell orders upon expiration of a first time period;
determine the first time period as a function of at least buy and sell order parameters; and
determine a clearing price from the matched buy and sell orders so as to maximize the quantity of the fungible asset traded upon execution of trades of the matched buy and sell orders

15. An apparatus according to claim 14, wherein the processing circuitry is further configured to control the apparatus to determine the time period as a function of at least buy and sell order parameters, the buy and sell order parameter including at least one of the received sell order quantity, the received buy order quantity, a reception rate of the received sell order quantity, a reception rate of the received buy order quantity, a range of the per unit selling price for the received sell order quantity, a range of the per unit buying price for the received buy order quantity, an order receipt time, and combinations thereof.

16. An apparatus according to claim 14, wherein the processing circuitry is further configured to control the apparatus to decrement the matched and executed buy orders and sell orders, from the posted buy orders and sell orders, following expiration of the first time period.

17. An apparatus according to claim 14, wherein the processing circuitry is further configured to control the apparatus to post the buy orders and the sell orders on an exchange such that the buy orders and the sell orders are observable by exchange participants.

18. An apparatus according to claim 14, wherein the processing circuitry is further configured to control the apparatus to originate a second time period after expiration of the first time period.

19. A method according to claim 18, wherein the processing circuitry is further configured to control the apparatus to include the buy orders and sell orders, not traded in the first time period, with buy orders and sell orders received and posted during the second time period.

20. An apparatus according to claim 14, wherein the processing circuitry is further configured to control the apparatus to post the buy orders and the sell orders such that at least the per unit price and the quantity of each of the buy orders and each of the sell orders are observable by exchange participants.

21. An apparatus according to claim 14, wherein the processing circuitry is further configured to control the apparatus to determine a clearing price as a fair market price associated with the maximized quantity of the fungible asset traded upon execution of trades of the matched buy and sell orders, and execute the trades of the matched buy and sell orders at the fair market price.

22. An apparatus according to claim 21, wherein the processing circuitry is further configured to control the apparatus to determine the fair market price according to an intersection of price versus quantity data between a buying curve and a selling curve for the fungible asset.

23. An apparatus according to claim 22, wherein the intersection of price versus quantity data comprises a price range for a particular quantity, and wherein the processing circuitry is further configured to control the apparatus to determine a fair market price by selecting a fair market price within the price range.

24. An apparatus according to claim 21, wherein the processing circuitry is further configured to control the apparatus to evaluate the determined fair market price according to one of a type of the fungible asset, a characteristic of the fungible asset, a historic market of the fungible asset, and combinations thereof.

25. An apparatus according to claim 18, wherein expiration of each time period is within a time range, and wherein the apparatus includes processing circuitry to conceal the buy orders, the sell orders, and any expired time periods, each within the time range of a current time period, from observation by exchange participants so as to prevent manipulation thereof by the exchange participants.

26. An apparatus according to claim 18, wherein expiration of each time period is within a time range, and wherein the apparatus includes processing circuitry to conceal the buy orders, the sell orders, and any expired time periods, each across a previous time period and within the time range of a current time period, from observation by exchange participants so as to prevent manipulation thereof by the exchange participants.

27. A computer program product comprising at least one non-transitory computer readable storage medium having computer program code stored thereon, the computer program code comprising:
program code for receiving a plurality of sell orders for the fungible asset, each sell order having a quantity of the fungible asset for sale and a per unit selling price associated therewith;
program code for receiving a plurality of buy orders for the fungible asset, each buy order having a quantity of the fungible asset wanted for purchase and a per unit buying price associated therewith;
program code for posting the buy orders and the sell orders on an exchange;
program code for matching buy orders and sell orders upon expiration of a first time period;
program code for determining the first time period as a function of at least buy and sell order parameters; and
program code for determining a clearing price from the matched buy and sell orders so as to maximize the quantity of the fungible asset traded upon execution of trades of the matched buy and sell orders.

28. A computer program product according to claim 27, wherein the program code for determining the time period further comprises program code for determining the time period as a function of at least buy and sell order parameters, the buy and sell order parameter including at least one of the received sell order quantity, the received buy order quantity, a reception rate of the received sell order quantity, a reception rate of the received buy order quantity, a range of the per unit selling price for the received sell order quantity, a range of the per unit buying price for the received buy order quantity, an order receipt time, and combinations thereof.

29. A computer program product according to claim 27, comprising program code for decrementing the matched and executed buy orders and sell orders, from the posted buy orders and sell orders, following expiration of the first time period.

30. A computer program product according to claim 27, comprising program code for posting the buy orders and the sell orders on an exchange such that the buy orders and the sell orders are observable by exchange participants.

31. A computer program product according to claim 27, comprising program code for originating a second time period after expiration of the first time period.

32. A computer program product according to claim 31, comprising program code for including the buy orders and sell orders, not traded in the first time period, with buy orders and sell orders received and posted during the second time period.

33. A computer program product according to claim 27, wherein the program code for posting the buy orders and sell orders further comprises program code for posting the buy orders and the sell orders such that at least the per unit price and the quantity of each of the buy orders and each of the sell orders are observable by exchange participants.

34. A computer program product according to claim 27, comprising program code for determining a clearing price as a fair market price associated with the maximized quantity of the fungible asset traded upon execution of trades of the matched buy and sell orders, and executing the trades of the matched buy and sell orders at the fair market price.

35. A computer program product according to claim 34, wherein the program code for determining a fair market price comprises program code for determining the fair market price according to an intersection of price versus quantity data between a buying curve and a selling curve for the fungible asset.

36. A computer program product according to claim 35, wherein the intersection of price versus quantity data comprises a price range for a particular quantity, and the program code for determining a fair market price comprises program code for selecting a fair market price within the price range.

37. A computer program product according to claim 34, wherein the program code for determining a fair market price comprises program code for evaluating the determined fair market price according to one of a type of the fungible asset, a characteristic of the fungible asset, a historic market of the fungible asset, and combinations thereof.

38. A computer program product according to claim 31, wherein expiration of each time period is within a time range, and the computer program product comprises program code for concealing the buy orders, the sell orders, and any expired time periods, each within the time range of a current time period, from observation by exchange participants so as to prevent manipulation thereof by the exchange participants.

39. A computer program product according to claim 31, wherein expiration of each time period is within a time range, and the computer program product comprises program code for concealing the buy orders, the sell orders, and any expired time periods, each across a previous time period and within the time range of a current time period, from observation by exchange participants so as to prevent manipulation thereof by the exchange participants.
